(19) United States
(12) Patent Application Publication
(10) Pub. No.: US 2008/0316785 A1
(43) Pub. Date: Dec. 25, 2008

(54) POWER SOURCE APPARATUS

(75) Inventor: Hiroshi USUI, Niiza-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sanken Electric Co., Ltd., Niiza-shi (JP)

(21) Appl. No.: 11/923,215

(22) Filed: Oct. 24, 2007

(30) Foreign Application Priority Data
Oct. 26, 2006 (JP) 2006-291505

(51) Int. Cl. H02M 7/06

(52) U.S. Cl. 363/126

(57) ABSTRACT

A power source apparatus has a series circuit connected between output terminals of a DC power source, the series circuit including a primary winding of a transformer and a switching element; a controller configured to control an ON/OFF operation of the switching element; and an output diode connected between terminals of a second winding of the transformer and configured to rectify an alternating current that is induced on the secondary winding when the controller turns on/off the switching element. The output diode includes a plurality of diodes that are connected in parallel with one another and are made of wide-gap semiconductor.

### BACKGROUND OF THE INVENTION

1. Field of the Invention

The present invention relates to a power source apparatus for providing a DC voltage, and particularly, to a technique of balancing currents in such a power source apparatus.

2. Description of the Related Art

FIG. 1 is a view showing a power source apparatus according to a related art. This apparatus has a bridge circuit DB1 for rectifying an AC voltage from an AC power source AC and a capacitor C1 for smoothing an output of the bridge circuit DB1. Ends of the capacitor C1 are connected to a series circuit that includes a primary winding P of a transformer T and a switching element Q1. The switching element Q1 is, for example, a MOSFET.

A secondary winding S of the transformer T is connected to a rectifying-smoothing circuit consisting of an output diode D5 and a capacitor C51. The output diode D5 consists of a diode D51 and a diode D52 that are connected in parallel with each other. The rectifying-smoothing circuit rectifies an AC voltage induced on the secondary winding S of the transformer T, smoothes the rectified voltage, and outputs the smoothed voltage to output terminals +Vout and −Vout.

Between the output terminals +Vout and −Vout, resistors R53 and R54 are connected as voltage dividing resistors for dividing the output voltage Vo. Also between the output terminals +Vout and −Vout, an error detector is connected. The error detector has a light emitting diode of a photocoupler PC1, a resistor R52, and a shunt regulator Z51 that are connected in series. The shunt regulator Z51 has a reference terminal R connected to a connection point of the resistors R53 and R54. Between a connection point of the resistors R53 and R54 and a connection point between the resistor R52 and the shunt regulator Z51, a capacitor C52 is connected.

The transformer T has an auxiliary winding C that is connected to a rectifying-smoothing circuit composed of a diode D4 and a capacitor C2. The rectifying-smoothing circuit rectifies an AC voltage induced on the auxiliary winding C of the transformer T, smoothes the voltage into a DC voltage, and supplies the DC voltage as a source voltage to a controller CONT.

The light emitting diode of the photocoupler PC1 in the error detector sends a feedback signal to a phototransistor of the photocoupler PC1. The feedback signal is an error voltage (a difference between the output voltage Vo and a reference voltage) based on which the controller CONT generates a control signal to turn on/off the switching element Q1. By controlling a duty factor of the control signal, the controller CONT maintains the output voltage Vo at a predetermined value.

Operation of the power source apparatus according to the related art of FIG. 1 will be explained. The AC power source AC provides an AC voltage, which is rectified by the bridge circuit DB1 and smoothed by the capacitor C1 into a DC voltage. The DC voltage is applied through a starting resistor R1 to the capacitor C2, thereby charging the capacitor C2. When the voltage of the charged capacitor C2 reaches a start voltage of the controller CONT, the controller CONT starts to operate. Namely, the controller CONT supplies a drive voltage from a G-terminal thereof to the gate of the switching element Q1, to start a switching (on/off) operation of the switching element Q1.

When the switching element Q1 is turned on, a current passes through a path extending along the capacitor C1, the primary winding P of the transformer T, the switching element Q1, and the capacitor C1, to accumulate energy in the transformer T. When the switching element Q1 is turned off, the energy accumulated in the transformer T is rectified and smoothed through the secondary winding S of the transformer T, the output diode D5 (composed of the diodes D51 and D52), and the capacitor C51 into a DC voltage. The DC voltage is provided as the output voltage Vo from the output terminals +Vout and −Vout.

The output voltage Vo from the output terminals +Vout and −Vout is divided by the resistors R53 and R54 and is sent to the reference terminal R of the shunt regulator Z51. The shunt regulator Z51 compares the voltage at the reference terminal R with an internal reference voltage of the shunt regulator Z51. If the voltage (proportional to the output voltage Vo) at the reference terminal R is higher than the reference voltage, the shunt regulator Z51 sets a cathode terminal K thereof to low. This results in passing a current through a path extending along the output terminal +Vout, the light emitting diode of the photocoupler PC1, the resistor R52, the shunt regulator Z51, and the output terminal −Vout, to transmit a feedback signal to the primary side through the photocoupler PC1.

The feedback signal transmitted to the primary side is received by the phototransistor of the photocoupler PC1 and is sent to a feedback terminal FB of the controller CONT. According to the feedback signal, the controller CONT controls the duty factor of a drive voltage supplied to the gate terminal of the switching element Q1. In this way, whenever the switching element Q1 is turned on/off, energy accumulated in the transformer T is adjusted to maintain the output voltage Vo at a predetermined value.

If the power source apparatus of FIG. 1 is designed to provide high output power, each element of the apparatus must have a large capacity and the output diode D5 also must have a large capacity. Any element having large capacity is generally manufactured in small numbers, and therefore, is expensive. For this, it is frequently practiced to connect a plurality of elements having small capacity in parallel with one another and employ the parallel arrangement in place of an element of large capacity because such small-capacity elements are manufactured in large numbers, and therefore, are inexpensive. In the power source apparatus of FIG. 1, the output diode D5 is made of the diodes D51 and D52 connected in parallel with each other, to achieve high output power.

The power source apparatus of the related art employs standard silicon (Si) diodes as the output diodes D51 and D52. FIG. 3B shows Vf-If curves of a silicon diode at different temperatures, where “Vf” is a forward voltage of the silicon diode and “If” is a forward current of the silicon diode. The silicon diode has characteristics that the forward voltage Vf increases as the forward current If increases and that a loss increases as the forward voltage Vf increases, to decrease the gradient of the forward current If. In addition, as the temperature increases, the forward current If increases and the forward voltage Vf decreases. When an output diode is made by connecting first and second silicon diodes in parallel with each other, the first silicon diode, for example, may generate more heat than the second silicon diode. In this case, the first silicon diode decreases its forward voltage to pass more current. This results in accelerating the generation of heat in the first silicon diode. To avoid the problem that current and heat concentrate on one silicon diode, the related art selects the diodes D51 and D52 from diodes having the same characteristics and installs the diodes on a single radiator so that the diodes are thermally coupled with each other to balance heat and current between the diodes. A dotted line of FIG. 1 around the diodes D51 and D52 indicates the thermal coupling achieved by the radiator.

FIG. 2 is a view showing a power source apparatus according to another related art. This apparatus drives two DC-DC converters in parallel in such a way as to balance output currents of the DC-DC converters. The apparatus includes the first DC-DC converter DD1, the second DC-DC converter DD2, a diode D1, a diode D2, a resistor RS1, and a resistor RS2.

The first DC-DC converter DD1 converts a DC voltage supplied to input terminals +IN and −IN into a second DC voltage. Similarly, the second DC-DC converter DD2 converts the DC voltage supplied to the input terminals +IN and −IN into the second DC voltage. The first and second DC-DC converters DD1 and DD2 are connected in parallel with each other with the use of a diode OR configuration.

Namely, a first output terminal of the first DC-DC converter DD1 is connected through the reverse-current preventing diode D1 to the output terminal +Vout and a second output terminal thereof is connected through the current detecting resistor RS1 to the output terminal −Vout. Similarly, a first output terminal of the second DC-DC converter DD1 is connected through the reverse-current preventing diode D2 to the output terminal +Vout and a second output terminal thereof is connected through the current detecting resistor RS2 to the output terminal −Vout.

The output terminal −Vout is connected to the first and second DC-DC converters DD1 and DD2. The first and second DC-DC converters DD1 and DD2 are connected to each other through respective current balance terminals. The current detecting resistor RS1 provides a detected voltage, which is amplified by an amplifier. The amplified voltage is passed through an impedance element and is outputted from the current balance terminal of the first DC-DC converter DD1. Similarly, the current detecting resistor RS2 provides a detected voltage, which is amplified by an amplifier. The amplified voltage is passed through an impedance and is outputted from the current balance terminal of the second DC-DC converter DD2.

Each of the first and second DC-DC converters DD1 and DD2 is configured like, for example, FIG. 1 and employs feedback control to stop if the output voltage Vo exceeds a predetermined value. Resumption from a complete halt needs a certain time, and therefore, dynamically responding to load is unachievable if the first and second DC-DC converters DD1 and DD2 are designed to separately drive load. Therefore, it is a usual practice to connect two DC-DC converters in parallel with each other through diodes, to form a diode OR structure. In the diode OR structure, each of the DC-DC converters can continuously operate with one of the DC-DC converters that provides a lower output voltage is put in a no-load state.

The diode OR structure usually employs silicon diodes. When passing a current, the silicon diode generates heat to decrease a forward voltage Vf and further increase an output current, thereby causing a current unbalance between the diodes that form the diode OR structure. To avoid the problem, the power source apparatus of the related art shown in FIG. 2 employs a current balancing scheme. Namely, a detected voltage from the current detecting resistor RS1 (RS2) is amplified by the amplifier, and the amplified voltage is passed through the impedance element and is output from the current balance terminal of a corresponding one of the first and second DC-DC converters DD1 and DD2. If there is a current difference, the ends of each impedance element produce a voltage. In order not to produce such a voltage, each of the first and second DC-DC converters DD1 and DD2 adjusts the output voltage Vo. Consequently, a current provided by the first DC-DC converter DD1 balances with a current provided by the second DC-DC converter DD2.

Another current balancing technique is disclosed in Japanese Unexamined Patent Application Publication No. H06-339263. This disclosure is an output current balancing DC-DC converter capable of balancing output currents and stabilizing operation even if the output voltage of one power source abnormally increases. According to this DC-DC converter, an output voltage corrector is arranged between the anode and cathode of an OR diode. The output voltage corrector includes a first amplifier. An inverting terminal of the first amplifier is connected to a voltage detecting resistor that is connected to the cathode of the OR diode, and a non-inverting terminal of the first amplifier is connected to a voltage detecting resistor that is connected to the anode side of the OR diode. An output terminal of the first amplifier is connected through a correction resistor to a connection point between two output voltage detecting resistors. A connection point between the two output voltage detecting resistors is connected to an input terminal of a second amplifier arranged in a controller. The second amplifier compares an output voltage of the output voltage corrector with a reference voltage and sends a comparison result to a power source adjusting feedback circuit.

### SUMMARY OF THE INVENTION

The related art shown in FIG. 1 thermally couples the two diodes D51 and D52 with each other to balance currents, and therefore, has a problem that a current unbalance easily occurs if there is a large thermal resistance or if the diodes have different characteristics.

The related art shown in FIG. 2 must arrange the current detecting resistors RS1 and RS2 on the output side of the DC-DC converters DD1 and DD2, and therefore, has a problem that the resistors cause losses. In addition, each DC-DC converter should have an internal circuit for balancing currents, to increase the number of parts and the cost.

According to the present invention, a power source apparatus capable of minimizing losses and the number of parts and balancing currents can be provided.

According to a first aspect of the present invention, provided is a power source apparatus having a series circuit connected between output terminals of a DC power source and including a primary winding of a transformer and a switching element; a controller configured to control an ON/OFF operation of the switching element; and an output diode connected between terminals of a second winding of the transformer and configured to rectify an alternating current that is induced on the secondary winding when the controller turns on/off the switching element. The output diode includes a plurality of diodes that are connected in parallel with one another and are made of wide-gap semiconductor.

According to a second aspect of the present invention, provided is a power source apparatus having a first power source unit configured to output a direct current; a second power source unit configured to output a direct current; a first diode made of wide-gap semiconductor and having an anode connected to an output terminal of the first power source unit; and a second diode made of the wide-gap semiconductor and having an anode connected to an output terminal of the second power source unit and a cathode connected to a cathode of the first diode.

### BRIEF DESCRIPTION OF THE DRAWINGS

FIG. 1 is a view showing a power source apparatus according to a related art;

FIG. 2 is a view showing a power source apparatus according to another related art;

FIG. 3A is a view showing Vf-If curves of an SiC diode;

FIG. 3B is a view showing Vf-If curves of an Si diode;

FIG. 4 is a view showing a power source apparatus according to a first embodiment of the present invention; and

FIG. 5 is a view showing a power source apparatus according to a second embodiment of the present invention.

### DESCRIPTION OF THE PREFERRED EMBODIMENT

Embodiments of the present invention will be explained in detail with reference to the accompanying drawings.

### First Embodiment

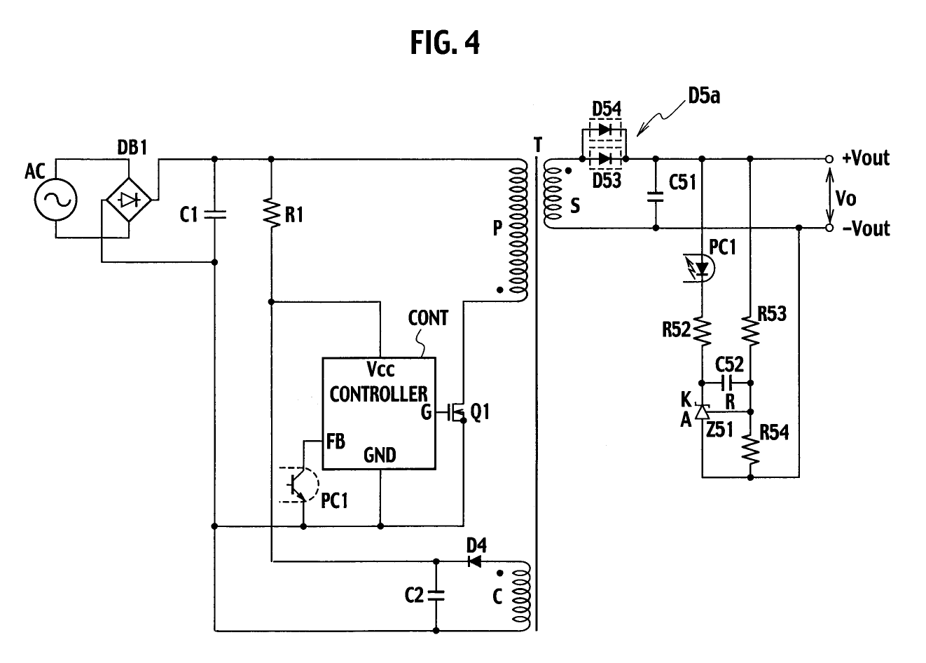

FIG. 4 shows a power source apparatus according to the first embodiment of the present invention. This power source apparatus utilizes a forward voltage drop occurring in a diode made of wide-gap semiconductor, to balance currents passing through output diodes. The wide-gap semiconductor is, for example, III-V-group semiconductor, in particular, nitride semiconductor such as gallium nitride (GaN) and silicon carbide (SiC).

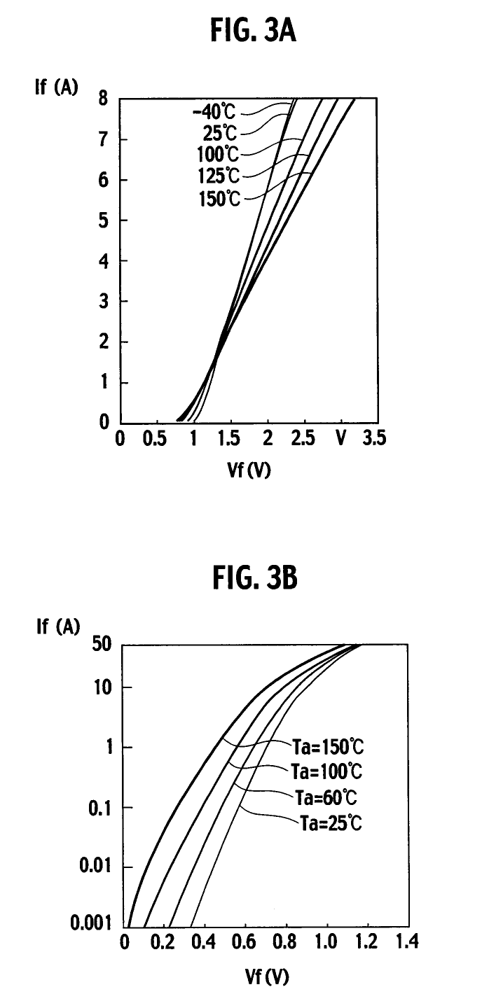

FIG. 3A is a view showing Vf-If curves of a diode made of SiC which is wide-gap semiconductor and FIG. 3B is a view showing Vf-If curves of a diode made of widely used silicon (Si). The diode made of SiC is hereinafter referred to as “SiC diode” and the diode made of Si as “Si diode.” The difference between the SiC diode and the Si diode will be explained with reference to the Vf-If curves of FIGS. 3A and 3B.

In FIG. 3B, the standard Si diode shows an increase in the forward voltage Vf in proportion to an increase in the forward current If, and therefore, can balance a current if conditions are ideal and the temperature is unchanged. In practice, however, the forward voltage Vf causes a loss to increase the temperature of the diode. The Si diode has a characteristic that the forward voltage Vf decreases as the temperature thereof increases. Namely, in practice, an increase in the forward current If does not result in an increase in the forward voltage Vf, and therefore, no current balance is achievable.

In FIG. 3A, the SiC diode shows an increase in the forward voltage Vf in proportion to an increase in the forward current If, and in addition, the forward voltage Vf increases as the temperature of the diode increases. When devices (for example, diodes) or circuits (for example, DC-DC converters) are connected in parallel with each other, the forward voltage Vf of each diode increases as the forward current thereof increases, thereby balancing currents passing through the devices or the circuits.

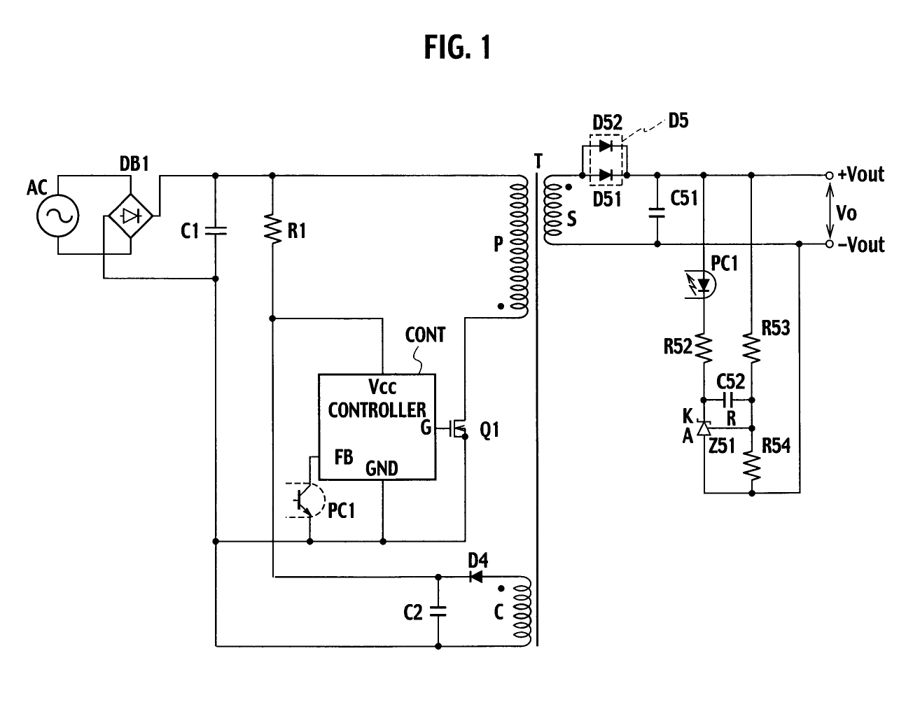

The power source apparatus according to the first embodiment of the present invention shown in FIG. 4 differs from the related art shown in FIG. 1 in that Example 1 employs an output diode D5a consisting of diodes D53 and D54 instead of the output diode D5 consisting of the diodes D51 and D52 of the related art. The difference will be explained in more detail.

In FIG. 4, the diodes D53 and D54 of the output diode D5a are connected in parallel with each other, to cope with high power. The diodes D53 and D54 are made of wide-gap semiconductor such as SiC and GaN and are connected to separate radiators, respectively.

Unlike the diodes D51 and D52 of the related art shown in FIG. 1, the diodes D53 and D54 of Example 1 are not required to be thermally coupled with each other. The diodes D53 and D54 are provided with the separate radiators as indicated with dotted lines in FIG. 4.

The SiC or GaN diode increases the forward voltage Vf thereof as the forward current If thereof increases. The forward voltage Vf of the SiC or GaN diode also increases as the temperature thereof increases. When devices (for example, the diodes D53 and D54) made of wide-gap semiconductor are connected in parallel with each other, the forward voltage Vf of each device increases as the forward current If thereof increases, thereby balancing currents passing through the parallel devices.

In FIG. 4, the diodes D53 and D54 are provided with the respective radiators, to balance currents at high sensitivity. It is possible to connect the two diodes to a single radiator like the related art of FIG. 1. The single-radiator arrangement also provides the effect of the present invention due to the characteristics of the wide-gap-semiconductor diodes. Namely, the wide-gap-semiconductor diodes such as SiC and GaN diodes can easily balance currents passing through the diodes only by simply connecting the diodes in parallel with each other.

The first embodiment has other advantages that no thermal coupling is required between the two diodes D53 and D54 and that these diodes can easily be operated in parallel. Variations in the forward voltages Vf of the diodes D53 and D54 are compensated by temperature increase, and therefore, currents passing through these diodes can ideally be balanced. The currents are balanced while the output voltage Vo is being kept at a constant value, and therefore, the output power of the diodes is balanced. Even if the diodes D53 and D54 are operated at a bias point where the forward current If is low in FIG. 3A, a resultant temperature increase will make the diodes operate at a stable point where currents passing through the diodes balance.

According to the first embodiment, the diodes D53 and D54 are made of wide-gap semiconductor such as gallium nitride (GaN) and silicon carbide (SiC). The diodes D53 and D54 may each have a Schottky barrier diode structure.

In this way, the power source apparatus according to the present embodiment employs the output diode for rectifying an alternating current induced on a secondary winding of a transformer from a plurality of wide-gap-semiconductor diodes that are connected in parallel with one another. Due to a forward voltage drop occurring in each wide-gap-semiconductor diode, currents passing through the diodes are balanced. The apparatus according to the present embodiment employs no special circuit for balancing currents, and therefore, causes no loss. Namely, the apparatus of the present embodiment can balance currents with a small number of parts, and therefore, is highly efficient, inexpensive, and reliable.

### Second Embodiment

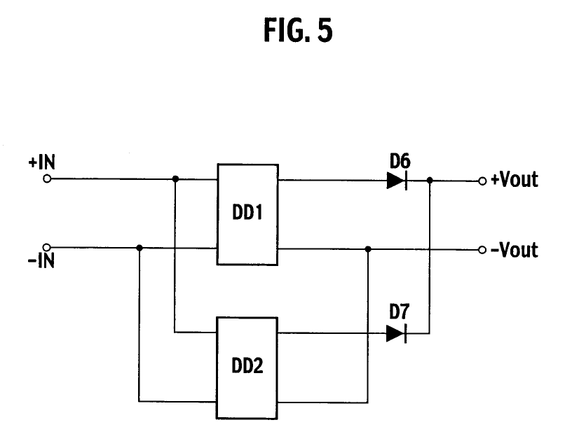

FIG. 5 shows a power source apparatus according to the second embodiment of the present invention. This apparatus utilizes the forward voltage drop characteristics of wide-gap-semiconductor diodes, to balance output currents of two DC-DC converters.

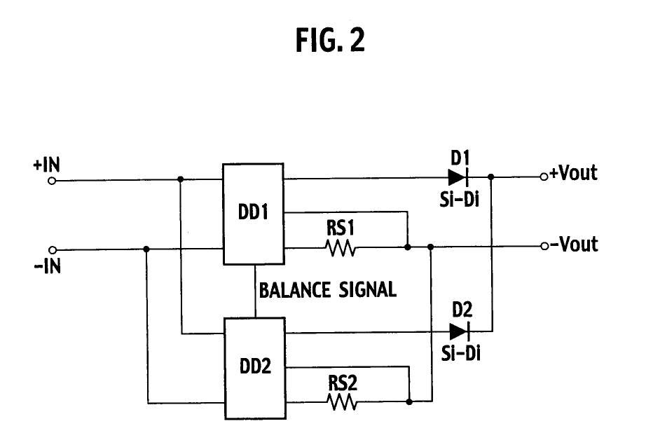

Compared with the power source apparatus of the related art shown in FIG. 2, the power source apparatus of the second embodiment shown in FIG. 5 does not have the current detecting resistors RS1 and RS2 and the current balance terminals provided for the first and second DC-DC converters DD1 and DD2. Although not shown in FIGS. 2 and 5, the elements such as amplifiers related to the current balancing operation arranged inside the first and second DC-DC converters DD1 and DD2 of the related art are also not installed in the apparatus of FIG. 5.

Instead of the reverse-current preventing diodes D1 and D2 of the related art of FIG. 2, the second embodiment of FIG. 5 employs reverse-current preventing diodes D6 and D7 made of wide-gap semiconductor such as SiC and GaN. The first DC-DC converter DD1 of FIG. 5 corresponds to a first power source unit according to the present invention and the second DC-DC converter DD2 of FIG. 5 corresponds to a second power source unit according to the present invention.

The power source apparatus according to the second embodiment employs wide-gap-semiconductor diodes as the reverse-current preventing diodes D6 and D7 for the parallel DC-DC converters DD1 and DD2. These diodes each increase a forward voltage Vf in proportion to an increase in a load current. Accordingly, the apparatus of the second embodiment can balance output currents of the two DC-DC converters without employing current detecting circuits or current balancing circuits.

Any variation in the forward voltages Vf of the diodes D6 and D7 is compensated by a temperature increase, to realize an ideal current balance. The current balance is achieved with an output voltage Vo being kept at a constant value, and therefore, output power is naturally balanced.

According to the present embodiment, the diodes D6 and D7 are made of wide-gap semiconductor such as gallium nitride (GaN) and silicon carbide (SiC). The diodes D6 and D7 may each have a Schottky barrier diode structure.

In this way, the power source apparatus according to the present embodiment includes the first wide-gap-semiconductor diode D6 having an anode connected to an output terminal of the first power source unit DD1 and the second wide-gap-semiconductor diode D7 having an anode connected to an output terminal of the second power source unit DD2 and a cathode connected to a cathode of the first diode D6. Due to a forward voltage drop occurring in each wide-gap-semiconductor diode, currents passing through the first and second diodes are balanced. The apparatus according to the present embodiment employs no special circuit for balancing currents, and therefore, causes no loss. Namely, the apparatus of the present embodiment can balance currents with a small number of parts, and therefore, is highly efficient, inexpensive, and reliable.

The present invention is applicable to switching power source apparatuses of high output power and power source systems that drive a plurality of power source units in parallel.

This application claims benefit of priority under 35USC §119 to Japanese Patent Application No. 2006-291505, filed on Oct. 26, 2006, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A power source apparatus comprising:
a series circuit connected between output terminals of a DC power source and including a primary winding of a transformer and a switching element;
a controller configured to control an ON/OFF operation of the switching element; and
an output diode connected between terminals of a second winding of the transformer and configured to rectify an alternating current that is induced on the secondary winding when the controller turns on/off the switching element, wherein
the output diode includes a plurality of diodes that are connected in parallel with one another and are made of wide-gap semiconductor.

2. The power source apparatus of claim 1, wherein
the plurality of diodes are Schottky-barrier diodes.

3. The power source apparatus of claim 1, wherein
the wide-gap semiconductor is one of gallium nitride and silicon carbide.

4. The power source apparatus of claim 2, wherein
the wide-gap semiconductor is one of gallium nitride and silicon carbide.

5. A power source apparatus comprising:
a first power source unit configured to output a direct current;
a second power source unit configured to output a direct current;
a first diode made of wide-gap semiconductor and having an anode connected to an output terminal of the first power source unit; and
a second diode made of the wide-gap semiconductor and having an anode connected to an output terminal of the second power source unit and a cathode connected to a cathode of the first diode.

6. The power source apparatus of claim 5, wherein
the first and second diodes are Schottky-barrier diodes.

7. The power source apparatus of claim 5, wherein
the wide-gap semiconductor is one of gallium nitride and silicon carbide.

8. The power source apparatus of claim 6, wherein
the wide-gap semiconductor is one of gallium nitride and silicon carbide.
